(19) United States
(12) Patent Application Publication
(10) Pub. No.: US 2007/0028227 A1
(43) Pub. Date: Feb. 1, 2007

(54) Code development system and method

(76) Inventor: Kenneth J. Lebowitz, Watertown, MA (US)

Correspondence Address: FISH & RICHARDSON PC, P.O. BOX 1022, MINNEAPOLIS, MN, 55440-1022, US

(21) Appl. No.: 11/189,428

(22) Filed: Jul. 26, 2005

(51) Int. Cl. G06F 9/44

(52) U.S. Cl. 717/168

(57) ABSTRACT

A system for programming a programmable device includes a data processing system adapted for linking to the programmable device and to a remote system for compiling code for the programmable device and software residing on the data processing system, the software including instructions for entering source code, transmitting the source code to the remote system, receiving compiled code from the remote system, and transmitting said compiled code to said programmable device.

### TECHNICAL FIELD

This invention relates to systems for developing code for programmable devices.

### BACKGROUND

Over the past decade, there has been growing interest among hobbyists and educators in the use of programmable microcontrollers to complete small-scale electronics projects. A programmable microcontroller is a complete computer—with memory, processor, and input/output data ports—that is contained on a single chip. The microcontroller can be easily integrated into circuits with other electronic components, such as motors, speakers, and sensors, to create electronic devices. In a typical project, the microcontroller serves as a control center—for example, turning motors on and off, sending electrical signals to speakers, and collecting input from sensors.

In order to control the components connected to a microcontroller, a user must write code for the microcontroller, compile that code, and then download the code to the microcontroller. At present, most hobbyists and educators use locally installed software—that is, software installed on their local computers—to write, compile, and download code for their microcontroller-based electronics projects. Three separate software applications may be used for each of the three steps (writing, compiling, and downloading), or a single locally installed application, often referred to as an Integrated Development Environment (IDE), may be used for writing, compiling, and downloading code.

A small number of web-based tools have been developed to enable users to write and compile their code on-line. For example, a web site called CompileSpot.com, which was developed by MicroEngineering Labs of Colorado Springs, Colo., provides a web-based text editor window for writing and editing code files. The CompileSpot.com system also transmits the user's code to a server, compiles that code on the server, and returns the compiled code to the user's local computer, along with any messages generated by the compiler. However, CompileSpot.com and other web-based tools for this purpose do not provide any way for users to send their compiled code files from the server directly to a microcontroller. Instead, a CompileSpot.com user who wishes to program a microcontroller must download the compiled code file from the server to a personal computer, save the code file, and then launch a locally installed code downloader application to send the compiled code to the microcontroller.

Regardless of whether locally installed or web-based tools are used to write and compile code, a physical connection between a user's local computer and the microcontroller is required to download compiled code to the microcontroller. Typically, a user integrates the microcontroller into a simple external circuit that creates a connection between the microcontroller and a data cable, which is in turn connected to a data port on the user's local computer—either a serial COM port or a Universal Serial Bus (USB) port. Depending on the type of port and microcontroller used, the user also may need to incorporate a second integrated circuit, or programming chip, into the circuit that connects the microcontroller to the data cable. In the case of serial COM port connections, the programming chip is a voltage converter, which moderates and inverts the voltage signals emitted by the serial port, producing voltage signals that are suitable for transmitting code to the microcontroller. In the case of USB port connections, the programming chip translates the USB data stream into serial output that is suitable for sending code to the microcontroller. In a relatively small percentage of cases, involving USB connections and certain types of microcontrollers, no programming chip is required. In all cases, once the code is sent to the microcontroller, the microcontroller stores the code in its internal memory.

### SUMMARY

In general, in one aspect, embodiments may include a system for programming a programmable device that includes a data processing system adapted for linking to the programmable device and to a remote system for compiling code for the programmable device and software residing on the data processing system, the software including instructions for entering source code, transmitting the source code to the remote system, receiving compiled code from the remote system, and transmitting the compiled code to the programmable device.

Particular embodiments may further include the following features: Software that transmits the compiled code to the programmable device without storing it in non-volatile storage associated with the data processing system.

In general, in another aspect, embodiments may include a method for programming a programmable device that includes connecting the device to a data processing system, using the data processing system to enter source code and transmit the source code to a remote system, and using the data processing system to receive compiled code corresponding to the source code from the remote system and transmitting the compiled code to the programmable device.

Particular embodiments may further include the following features: The computer system transmits the compiled code to the programmable device without storing it in non-volatile storage associated with the data processing system.

In general, in another aspect, embodiments may include a system for programming a programmable device that includes a client computer adapted to communicate data to the programmable device, a server adapted to communicate with the client computer over a network, compiler software residing on the server, the compiler software including instructions for receiving source code instructions from the client computer and generating executable instructions for the programmable device in response to the received source code instructions, code insertion software residing on the server, the code insertion software including instructions for causing the client computer to insert executable code into the programmable device, and client configuration software residing on the server, the client configuration software including instructions for transmitting the code insertion software t6 the client computer.

Particular embodiments may further include the following features: The network is the Internet. The code insertion software includes a Java applet. The code insertion software is responsive to a single user command to retrieve executable code for the programmable device from the server and insert the executable code into the programmable device. User interface software residing on the server, the user interface software including instructions for displaying to a user a project guide containing human readable instructions for use of the system while simultaneously displaying an interface permitting a user to transmit source code instructions from the client computer to the server.

In general, in another aspect, embodiments may include a method for programming a programmable device that includes connecting the device to a client computer, connecting the client computer to a server over a network, transmitting source code instructions from the client computer to the server, generating executable instructions for the device at the server, transmitting the executable instructions from the server to the client computer, and transmitting from the server to the client computer instructions for causing the client computer to insert the executable instructions into the programmable device.

Particular embodiments may further include the following features: The network is the Internet. The instructions for causing the client computer to insert the executable instructions include a Java applet. The executable instructions are transmitted from the client computer to the programmable device. The executable instructions are transferred from the server to the client computer and from the client computer to the programmable device all in response to a single command received from a user.

Particular embodiments may further include the following features: A user interface for receiving the source code instructions from a user and transmitting the source code instructions to the server is displayed on the client computer. A project guide is displayed to a user, simultaneously with the user interface, which contains human readable instructions for training a user to enter the source code instructions into the user interface.

In general, in another aspect, embodiments may include a method for programming a programmable device that includes, at a server, receiving source code instructions from a client computer over a network and compiling the source code into instructions executable by the programmable device, transmitting the executable code from the server to the client computer, and transmitting from the server to the client computer instructions for causing the client computer to insert the executable code into the programmable device.

Particular embodiments may further include the following features: The instructions for causing the client computer to insert the executable code into the programmable device includes a Java applet.

In general, in another aspect, embodiments may include a computer software program product the includes software instructions residing on a computer readable medium, the program product adapted for programming a programmable device and including instructions for, at a server, receiving source code instructions from a client computer over a network and compiling the source code into instructions executable by the programmable device, transmitting the executable code from the server to the client computer, and transmitting from the server to the client computer instructions for causing the client computer to insert the executable code into the programmable device.

Particular embodiments may further include the following features: The instructions for causing the client computer to insert the executable code into the programmable device include a Java applet.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows hardware and software components of an embodiment the invention.

FIG. 2 shows a flow diagram of the process for registering a user account.

FIG. 3 shows an exemplary user registration web page.

FIG. 4 shows a flow diagram of the process for logging in to the password-protected web site that hosts the Java applet and native code library.

FIG. 5 shows an exemplary welcome page.

FIG. 6 shows a flow diagram of the process for downloading and installing the native code library.

FIG. 7 shows a flow diagram of the process for launching the programming system.

FIG. 8 shows the user interface for a Java applet.

FIG. 9 shows the buttons in the Java applet's toolbar.

FIG. 10 shows a flow diagram of the process for creating, saving, opening, and starting a new code file.

FIG. 11 shows a flow diagram of the process for compiling a code file.

FIG. 12 shows a flow diagram of the process for downloading a code file.

FIG. 13 shows an exemplary web-based project guide.

FIG. 14 shows an exemplary web-based project guide with the programming system visible.

### DETAILED DESCRIPTION

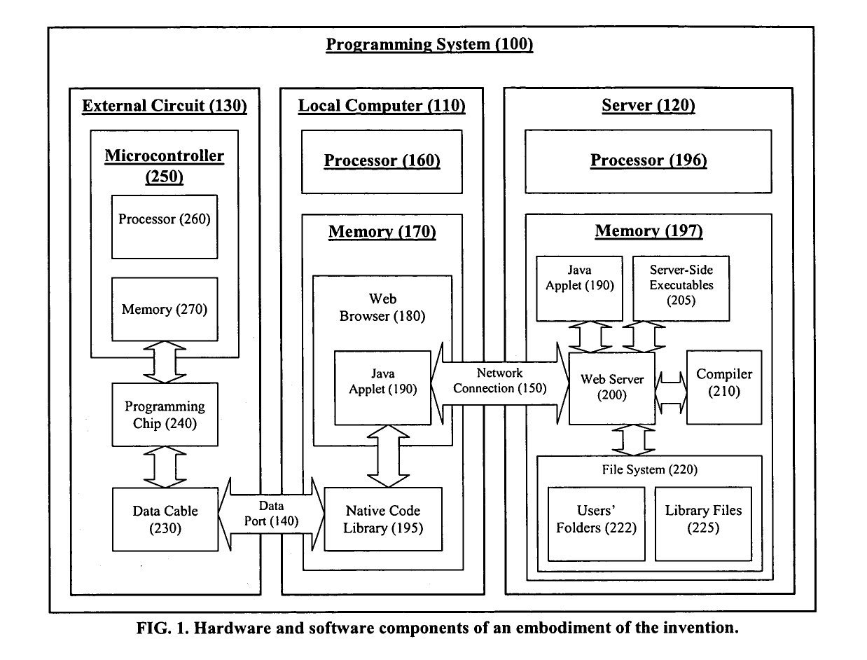

Referring to FIG. 1, programming system 100 comprises local computer 110, server 120, and external circuit 130. External circuit 130 is linked to local computer 110 via data port 140 and matching data cable 230. Local computer 110 is linked to server 120 via network connection 150. In one embodiment, network connection 150 may be the Internet. Data port 140 and data cable 230 may, for example, be serial COM type or Universal Serial Bus (USB) type.

Local computer 110 may be a standard personal computer running an operating system, such as Microsoft Windows. Alternatively, local computer 110 may be any kind of system capable of executing software, such as a personal digital assistant, or the like. Local computer 110 includes processor 160 and memory 170. Memory 170 includes web browser 180, for example Microsoft Internet Explorer or Mozilla FireFox. Memory 170 also includes Java applet 190 and native code library 195. For Microsoft Windows users, native code library 195 may be a Dynamic Linked Library (.dll) file; for Macintosh users, native code library 195 may be a Java Native Interface Library (.jnilib) file. Native code library 195 contains information about the type of microcontroller that will be programmed by the system, as well as the type of data port that will be used to connect to the microcontroller, enabling Java applet 190 to communicate with data port 140. The installation and operation of Java applet 190 and native code library 195 will be further described herein.

Server 120 may be any kind of processing system capable of serving data over a network, including a computer or group of computers. Server 120 includes processor 196 and memory 197. Memory 197 includes Java applet 190, web server software 200, sever-side executables 205, compiler software 210, and file system 220 for permanent storage of data files. Web server software 220 may be, for example, Apache web server. Server-side executables 205 may be, for example, Common Gateway Interface (CGI) scripts that enable communication among web server 200, compiler 210, and file system 220. Compiler software 210 may be, for example, PICCLite from HiTech Software or any compiler capable of compiling code for microcontrollers. Like all Java applets, Java applet 190 is stored in server memory 197, but it is launched and run within web browser 180. Hence, FIG. 1 depicts Java applet 190 both in server memory 197 and local computer memory 170.

External circuit 130 includes data cable 230 and microcontroller 250, and may or may not include programming chip 240. If present, programming chip may, for example, be the ST 32328 from STMicroelectronics. Microcontroller may, for example, be the PIC 16F877 from Microchip Technologies. Microcontroller includes processor 260 and memory 270. Microcontroller memory is solid-state flash memory, which is designed to store compiled code sent through data cable 230, even in the absence of an external power source.

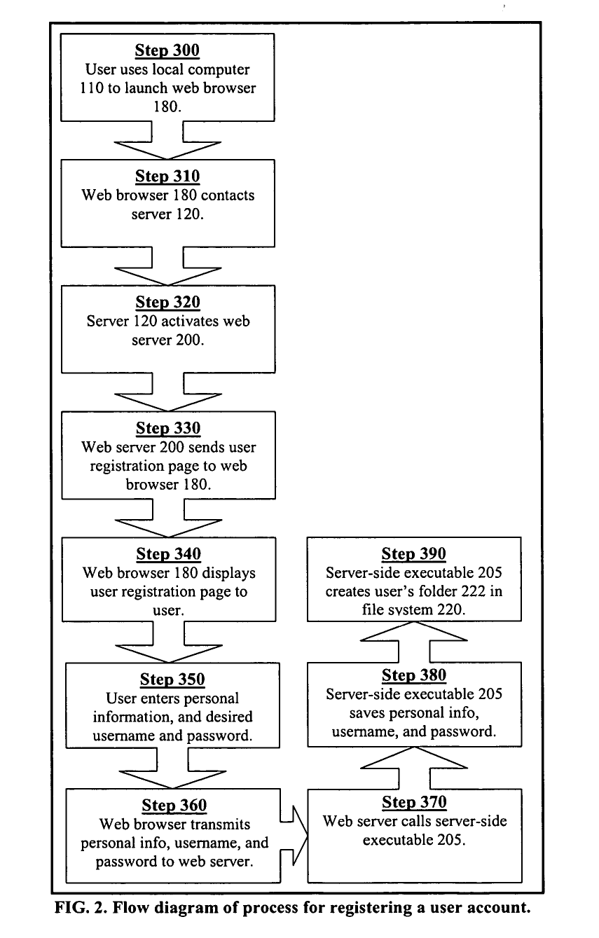

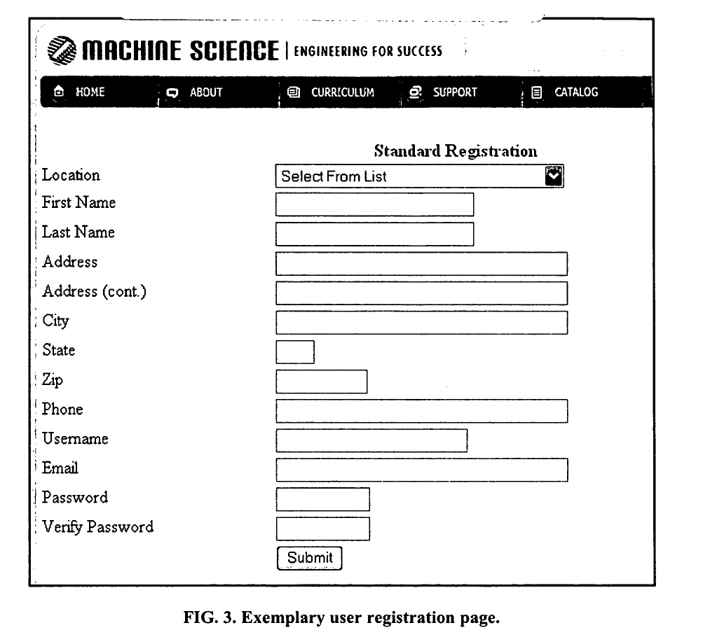

The steps to register an account to access the password-protected web site that hosts the programming system will now be described. Referring now to FIG. 2, user uses local computer 110 to launch web browser 180 (step 300) and uses browser to contact server 120 (step 310). For example, user may provide the URL of server 120 to web browser 180, which causes an HTTP message to be sent to server 120. Server 120 responds by activating web server 200 (step 320), which responds by transmitting a user registration web page back to web browser 180 (step 330), which displays the user registration page to the user (step 340). FIG. 3 shows an exemplary user registration page according to an embodiment of the invention. Using web browser, user enters personal information, as well as a desired username and password (step 350). Web browser sends user's personal information, username, and password to web server (step 360). Web server calls server-side executable 205 (step 370), which saves user's personal information, username, and password in file system 220 (step 380). Server-side executable also creates user folder 222 in file system 220 to store user's code files (step 390).

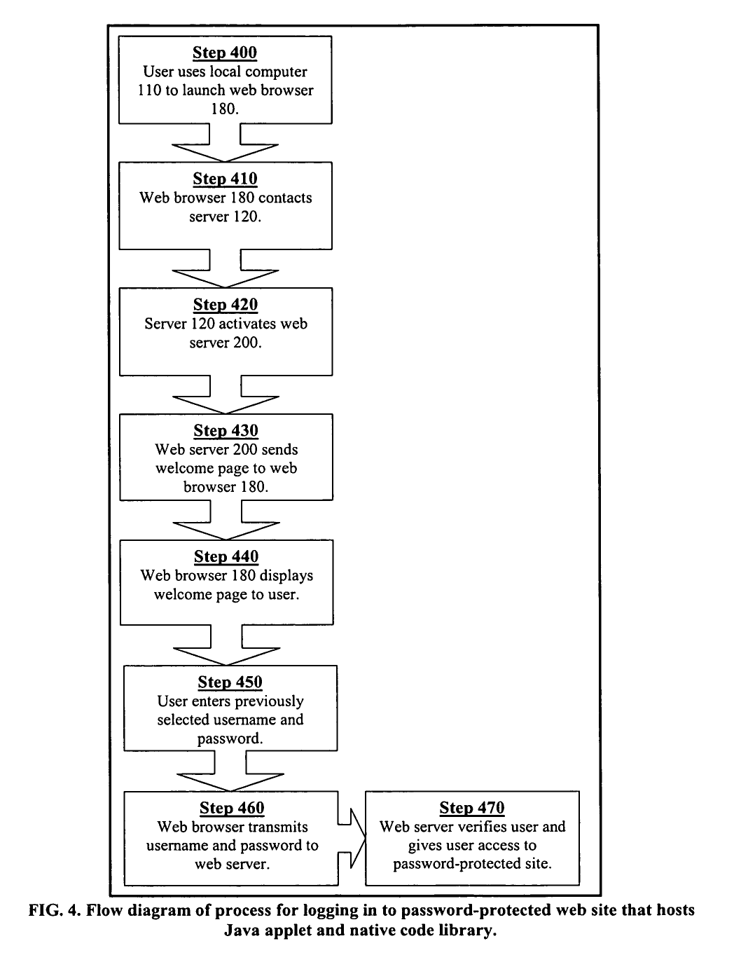

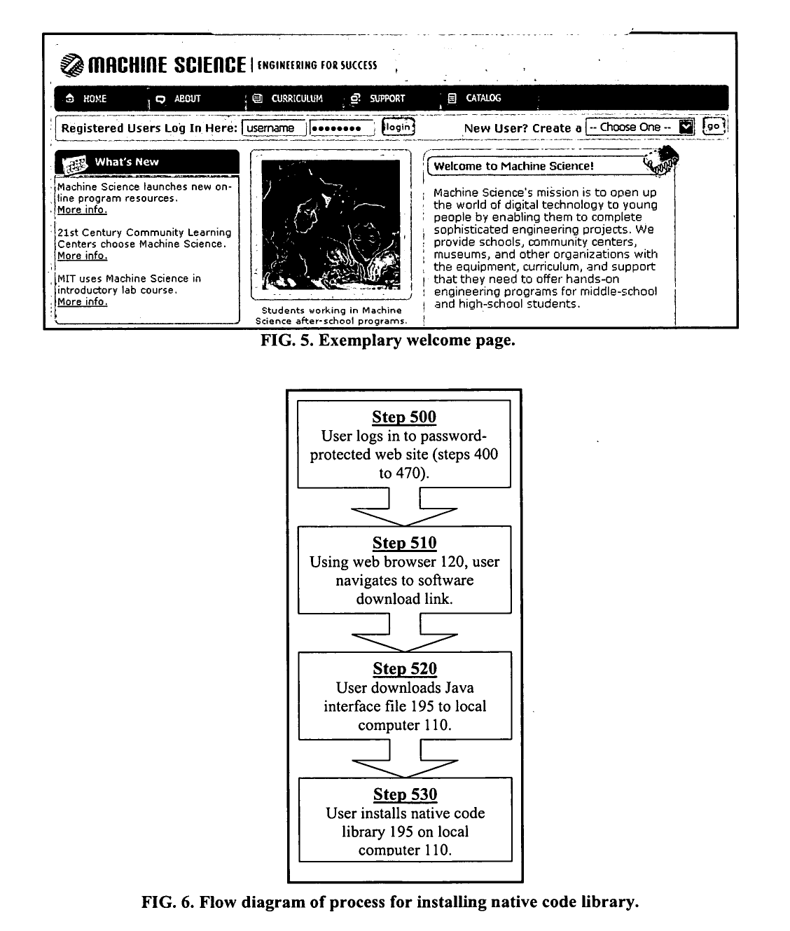

The steps to log in to the password-protected web site that hosts the programming system will now be described. Referring now to FIG. 4, user uses local computer 110 to launch web browser (step 400). Web browser contacts server 120 (step 410). Server 120 responds by activating web server 200 (step 420), which responds by transmitting a welcome web page back to web browser 180 (step 430). Web browser displays welcome page for user (step 440). FIG. 5 shows an exemplary welcome web page according to an embodiment of the invention. Using welcome web page, user enters previously selected username and password (step 450), which are transmitted back to web server 200 (step 460). Web server verifies the user's identity and gives the user access to password-protected web site (step 470).

The steps to install the native code library will now be described. Referring now to FIG. 6, user logs in to system (step 500). User uses web browser to navigate to software download link (step 510). User downloads native code library 195 (step 520) and then installs it on local computer 110 (step 530). Native code library installation may be accomplished by launching an executable installation file, or by saving native code library in the appropriate directory in local computer memory 170.

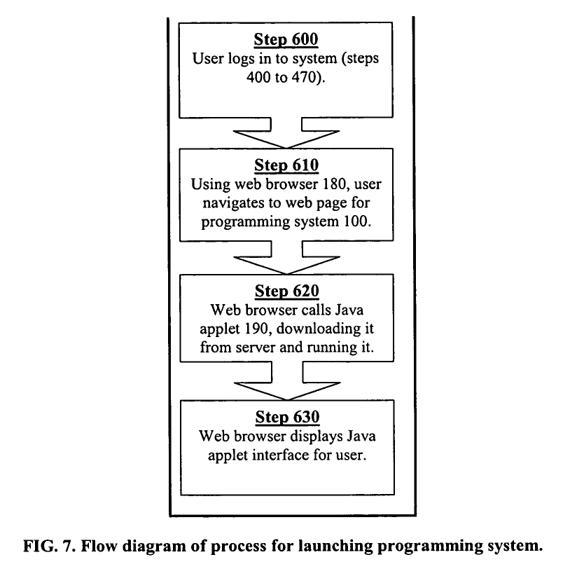

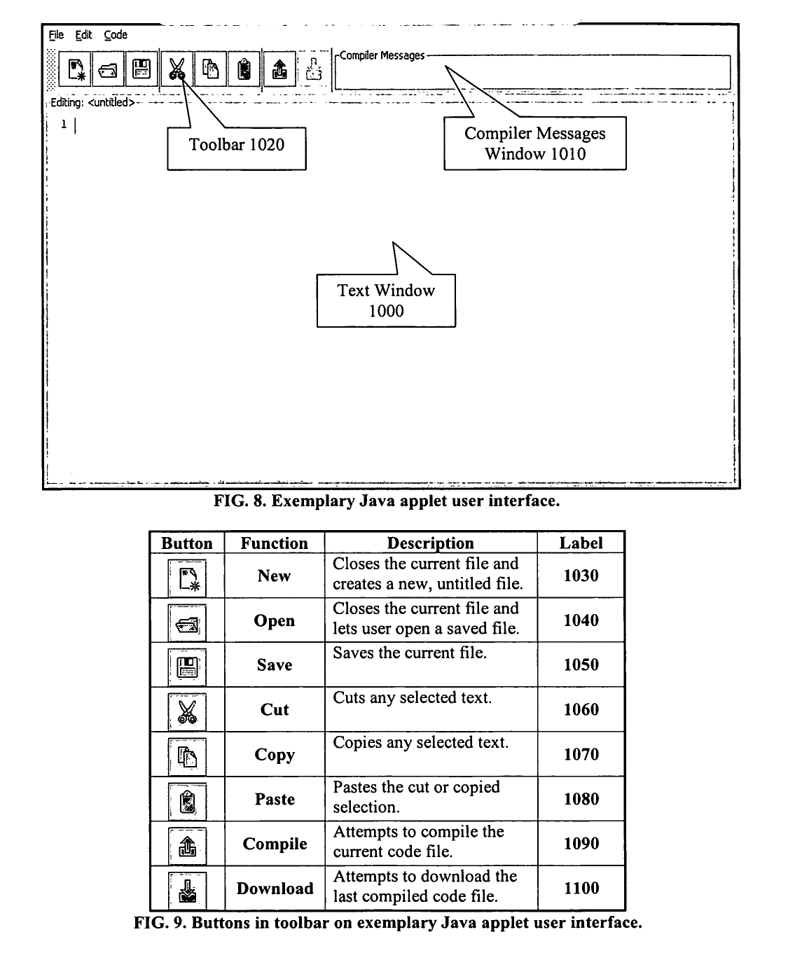

The steps to launch the programming system will now be described. Referring now to FIG. 7, user logs in to system (Step 600). User navigates to programming system web page using web browser 180 (step 610). Web browser calls Java applet 190, downloads Java applet from web server to local computer 110, and runs Java applet (step 620). Web browser displays Java applet user interface to user (step 630). FIG. 8. shows the user interface for the Java applet, which includes text window 1000, compiler messages window 1010, and toolbar 1020. FIG. 9 shows the buttons in the Java applet user interface toolbar. These include New button 1030, Open button 1040, Save button 1050, Cut button 1060, Copy button 1070, Paste button 1080, Compile button 1090, and Download button 1100.

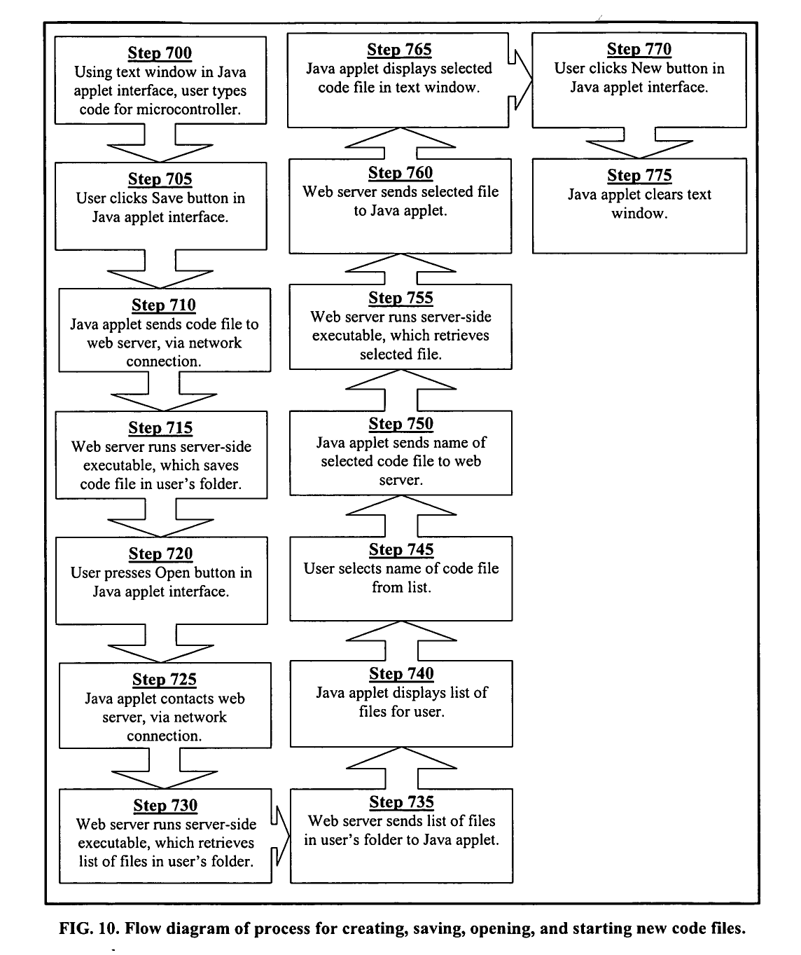

The steps to create a code file, save a code file, open an existing code file, and start a new code file will now be described, with reference to FIG. 10. To create a code file, user types code for the microcontroller in text window 1000 within the Java applet interface (step 700). To save a code file, user presses Save button 1050 in Java applet interface (step 705). Java applet then sends code file to server 120, via network connection 150 (step 710). Web server runs server-side executable 205, which saves code in user's code folder 222 (step 715). To open an existing code file, user presses Open button 1040 in the Java applet interface (step 720). Java applet 190 contacts web server 200, via network connection (step 725). Web server runs server-side executable, which retrieves list of files in user folder 222 (step 730). Web server sends list of files in user folder 222 to Java applet (step 735), which displays list of files for user (step 740). User selects desired file from list (step 745). Java applet sends name of selected file to web server 200 (step 750). Web server runs server-side executable 205, which retrieves selected file from user folder 222 (step 755). Web server sends selected file to Java applet (step 760), which displays selected file in text window (step 765). To start a new code file, user presses New button 1030 in Java applet interface (step 770). Java applet clears text window 1000 (step 775).

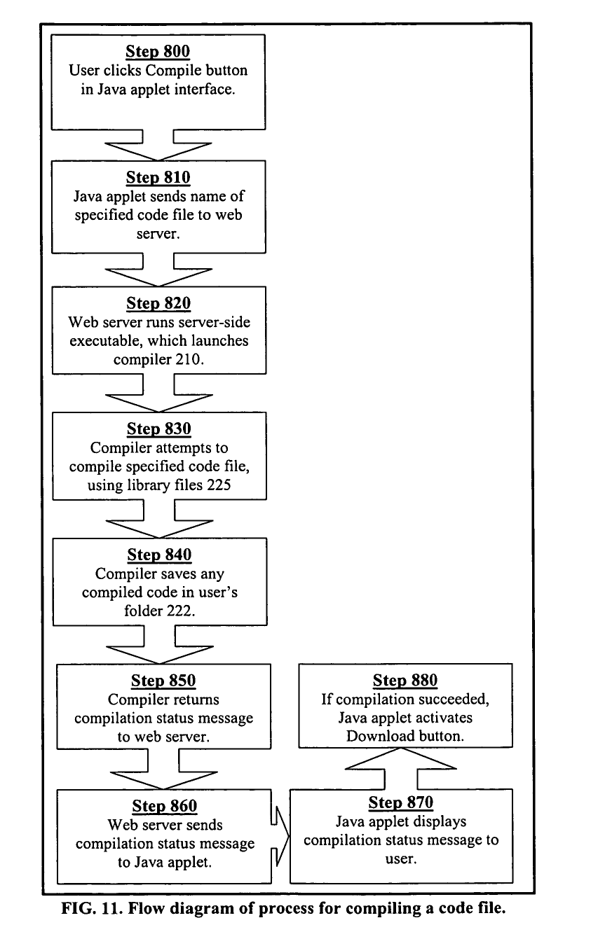

The steps to compile a code file will now be described. Referring now to FIG. 11, user presses Compile button 1090 in Java applet interface (step 800). Java applet sends name of active code file to web server 200 (step 810). Web server 200 runs server-side executable 205, which launches compiler 210 (step 820). Compiler attempts to compile specified code file, using library files 225, which contain predefined functions that may or may not be called in the code file being compiled (step 830). If compilation is successful, compiler saves code file in user's folder 222 (step 840). Compiler returns compilation status message web server (step 850), which sends compilation status message to Java applet (step 860). Java applet displays compilation status message for user (step 870). If compilation was successful, Java applet activates Download button 1100 in Java applet interface (step 880).

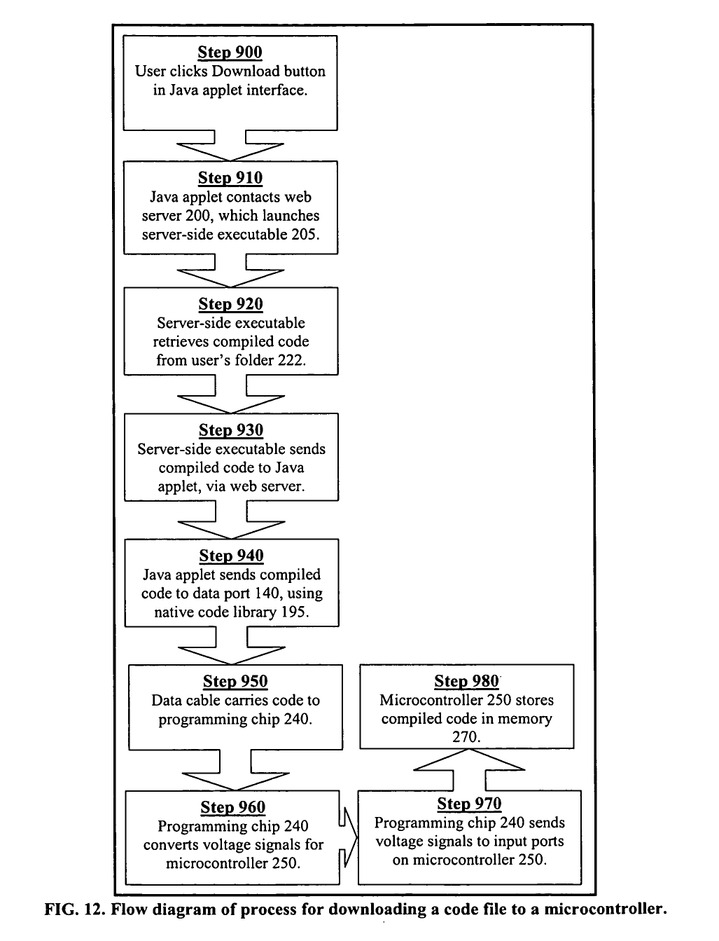

The steps to download a code file to a microcontroller, using the programming system, will now be described. Referring now to FIG. 12, user clicks the Download button 1100 in Java applet interface (step 900). Java applet contacts web server 200, which contacts server-side executable 205 (step 910). Server-side executable retrieves compiled code from user folder 222 (step 920). Compiled code is sent to Java applet, via web server (step 930). Java applet sends compiled code to data port 140, using native code library 195 to communicate with the port (step 940). Data cable 230 sends compiled code to programming chip 240 (step 950). Programming chip 240 converts voltage signals to appropriate level and type for microcontroller programming (step 960). Programming chip sends voltage signals to input ports on microcontroller 250 (step 970). Finally, microcontroller 250 stores code in memory 270 (step 980).

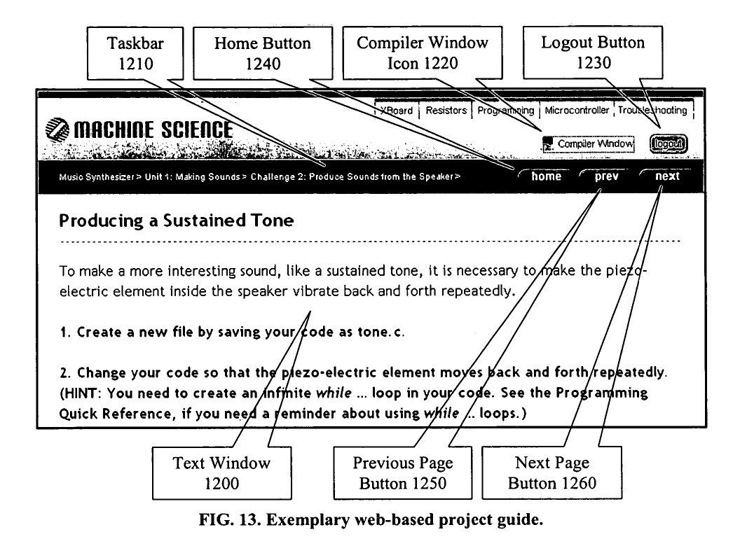

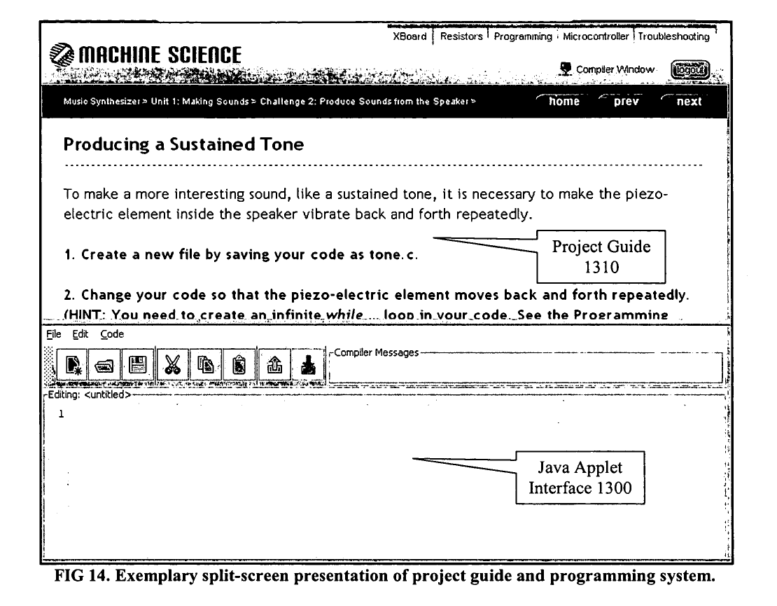

A framework for presenting the web-based programming system in conjunction with web-based project guides will now be described. FIG. 13 shows an exemplary web-based project guide. Project guide includes text window 1200 and task bar 1210. Task bar 1210 includes Compiler Window icon 1220, Logout button 1230, Home button 1240, Previous Page button 1250, and Next Page button 1260. In this configuration, a user launches the programming system by clicking Compiler Window icon 1220. Clicking icon splits the browser into two icon splits the browser into two resizable windows, with the code development system in the lower window and the project guide in the upper window. FIG. 14 shows an exemplary split-screen presentation of the project guide and the programming system. Split screen includes Java applet interface 1300 and project guide 1310. User may continue to navigate through web-based project guide, using Home button 1240, Previous Page button 1250, and Next Page button 1260, while keeping Java applet interface in use.

Other embodiments not specifically described herein are also within the scope of the following claims. Nothing in foregoing description is intended in any way to limit the scope of the following claims, which are intended to be given their broadest possible scope consistent with the ordinary meaning of the claim language.

What is claimed is:

1. A system for programming a programmable device comprising:
a data processing system adapted for linking to said programmable device and to a remote system for compiling code for the programmable device; and
software residing on said data processing system, said software including instructions for entering source code, transmitting said source code to said remote system, receiving compiled code from said remote system, and transmitting said compiled code to said programmable device.

2. The system of claim 1, wherein said software transmits said compiled code to said programmable device without storing it in non-volatile storage associated with said data processing system.

3. A method for programming a programmable device comprising:
connecting the device to a data processing system;
using the data processing system to enter source code and transmit the source code to a remote system; and
using said data processing system to receive compiled code corresponding to said source code from said remote system and transmitting said compiled code to said programmable device.

4. The method of claim 3, wherein said computer system transmits said compiled code to said programmable device without storing it in non-volatile storage associated with said data processing system.

5. A system for programming a programmable device comprising:
a client computer adapted to communicate data to said programmable device;
a server adapted to communicate with said client computer over a network;
compiler software residing on said server, said compiler software including instructions for receiving source code instructions from said client computer and generating executable instructions for said programmable device in response to the received source code instructions;
code insertion software residing on said server, said code insertion software including instructions for causing said client computer to insert executable code into said programmable device; and
client configuration software residing on said server, said client configuration software including instructions for transmitting said code insertion software to said client computer.

6. The system of claim 5, wherein said network is the Internet.

7. The system of claim 5, wherein said code insertion software comprises a Java applet.

8. The system of claim 5, wherein said code insertion software is responsive to a single user command to:
a. retrieve executable code for said programmable device from said server; and
b. insert said executable code into said programmable device.

9. The system of claim 5, further comprising user interface software residing on said server, said user interface software including instructions for displaying to a user a project guide containing human readable instructions for use of said system while simultaneously displaying an interface permitting a user to transmit source code instructions from said client computer to said server.

10. A method for programming a programmable device comprising:
a. connecting said device to a client computer;
b. connecting said client computer to a server over a network;
c. transmitting source code instructions from said client computer to said server;
d. generating executable instructions for said device at said server;
e. transmitting said executable instructions from said server to said client computer;
f. transmitting from said server to said client computer instructions for causing said client computer to insert said executable instructions into said programmable device.

11. The method of claim 10, wherein said network is the Internet.

12. The method of claim 10, wherein said instructions for causing said client computer to insert said executable instructions comprises a Java applet.

13. The method of claim 10, further comprising transmitting said executable instructions from said client computer to said programmable device.

14. The method of claim 13, wherein said executable instructions are transferred from said server to said client computer and from said client computer to said programmable device all in response to a single command received from a user.

15. The method of claim 10, further comprising displaying on said client computer a user interface for receiving said source code instructions from a user and transmitting said source code instructions to said server.

16. The method of claim 15, further comprising displaying to a user, simultaneously with said user interface, a project guide containing human readable instructions for training a user to enter said source code instructions into said user interface.

17. A method for programming a programmable device comprising:
a. at a server, receiving source code instructions from a client computer over a network,
b. at said server, compiling said source code into instructions executable by said programmable device;
c. transmitting said executable code from said server to said client computer; and
d. transmitting from said server to said client computer instructions for causing said client computer to insert said executable code into said programmable device.

18. The method of claim 17, wherein said instructions for causing said client computer to insert said executable code into said programmable device comprises a Java applet.

19. A computer software program product comprising software instructions residing on a computer readable medium, the program product adapted for programming a programmable device and comprising instructions for:
a. at a server, receiving source code instructions from a client computer over a network,
b. at said server, compiling said source code into instructions executable by said programmable device;
c. transmitting said executable code from said server to said client computer; and
d. transmitting from said server to said client computer instructions for causing said client computer to insert said executable code into said programmable device.

20. The software product of claim 19, wherein said instructions for causing said client computer to insert said executable code into said programmable device comprises a Java applet.
